(19) United States
(12) Patent Application Publication
(10) Pub. No.: US 2009/0101733 A1
(43) Pub. Date: Apr. 23, 2009

(54) Controlled dispensing hand shower

(76) Inventors: Alexander G. Popov, St. Petersburg (RU); Vassili G. Popov, Potomac, MD (US)

Correspondence Address: VASSILL G. POPOV, 7905 CRESTDALE DRIVE, POTOMAC, MD, 20854, US

(21) Appl. No.: 11/974,900

(22) Filed: Oct. 17, 2007

(51) Int. Cl. B05B 9/00; A47K 3/28

(52) U.S. Cl. 239/310; 239/525; 4/615

(57) ABSTRACT

A controlled dispensing hand-held shower to dissolve water-soluble or water dispersible substance into the water of shower which has rotatable mixing chamber in the nozzle. Concentration in the water of soluble or dispersible substances, that are placed in the mixing chamber may be changed by means of changing relative position of the holes located in the fixed dividing part and holes located in the bottom of the mixing chamber The fixed dividing element may be incorporated with body of handle of the shower.

### CROSS-REFERENCE TO RELATED APPLICATIONS

| Date | Code | Application Number |
|---|---|---|
| n/a | n/a | n/a |

### STATEMENT REGARDING FEDERALLY SPONSORED RESEARCH OR DEVELOPMENT

Current invention not has no relation to any a inventions made under federally sponsored research and development.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention CONTROLLED DISPENSING HAND SHOWER relates to a controlled dispensing device and more particularly, to a shower head with water-soluble or water-dispersible solid substance dispensers which be adapted for dispensing these substances into the water stream of the shower head during the use thereof.

In the today's ecological situation, when the huge amounts of irritants and allergens everyday attack human skin there is a great need for a skin cleaning hygienic device which allows to make the process of showering effective, time-saving, protects as well as leaves skin smoth and well conditioned and soft. The dispensing shower meets this requirements.

The dispensing shower for solid substances, allows to consumers to save time in their hygienic procedures, and make them more useful.

Moreover controlled dispensing shower, allows to use the dissolving or dispersible substances more economical and make characteristics of solution more individual for customers.

There are exist now such kinds of dispensing shower heads

Pat. No. WO0011997 issued to Osaka Toshifumi on Mar. 9, 2000 describes a soap dispenser that can be employed as a controlled hand-held shower head for dispensing solid soap of special shapes

This invention has a mixing chamber in handle of the shower head in which the soap is stored.

However, this embodiment of controlled dispensing shower has several disadvantages
too small space of mixing chamber;
very complicated solution of sealing task to avoid of leaking problem;
very high cost of manufacturing of moulds for handle.

In order to avoid these disadvantages it would be more preferable to use a controlled dispenser, which has the mixing chamber in the nozzle of the shower head.

Pat GB 2430617A issued to Anthony John Collier on Apr. 4, 2007 describes such a dispenser for solid substances, but the disadvantage of this dispenser is that—it is not controlled one.

### BRIEF SUMMARY OF THE INVENTION

A primary object of the present invention is to provide a controlled dispensing shower head that it is free of the mentioned drawbacks, in the following ways:
it uses the mixing chamber in nozzle of the shower head, which may holds one or more water-soluble or water-dispersible solid substances;
it has fixed dividing element with one or more holes
it has a removable face plate
   and more another components.

Additional purpose of the present invention is to provide a controlled dispensing shower which is simple, easy to use in practice, as well as safe and more effective in operation, and has a significantly low cost of manufacturing. This objective is being achieved by incorporating fixed dividing element as part of the base of the shower handle in the form of the ledges on the base of the shower.

### BRIEF DESCRIPTION OF THE SEVERAL VIEWS OF THE DRAWING

FIG. 1 is schematic view of the cross-section of first embodiment of a hand-held controlled dispensing shower head according to the present invention.

FIG. 2 is a schematic view of the cross-section of second embodiment of a hand-held controlled dispensing shower head according to the present invention

FIG. 3 is a schematic view of the section of the rotatable part of the nozzle with incorporated mixing chamber according to the present invention.

FIG. 4 is a schematic view of the ledge of the handle according to Claim 2 of the present invention.

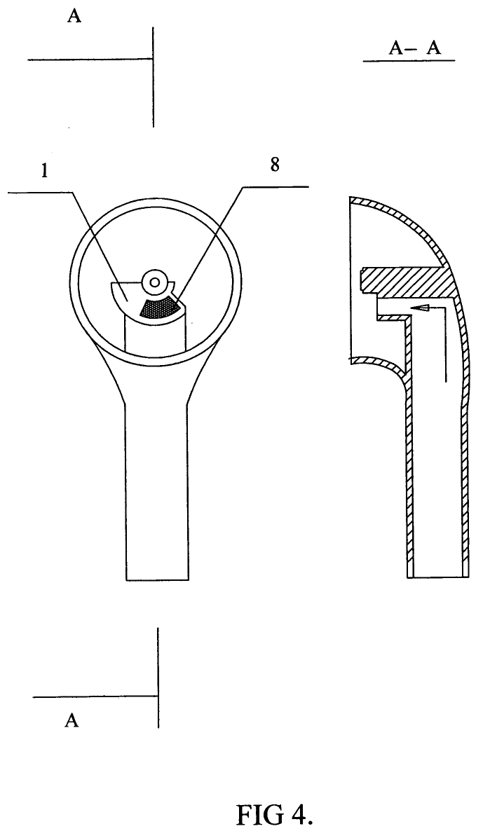

FIG. 5 is schematic view of the mixing chamber and the handle with ledges according to the Claim 2 of the present invention for the case of a closed stream inside the mixing chamber.

FIG. 6 is schematic view of the mixing chamber and the handle with ledges according to the Claim 2 of the present invention for case of partially opened stream inside the mixing chamber.

### DETAILED DESCRIPTION OF THE INVENTION

The present invention CONTROLLED DISPENSING HAND SHOWER relates to a controlled dispensing device and more particularly, to a shower head with water-soluble or water-dispersible solid substance dispensers which is adapted for dispensing these substance into the water stream of the shower head during the use thereof

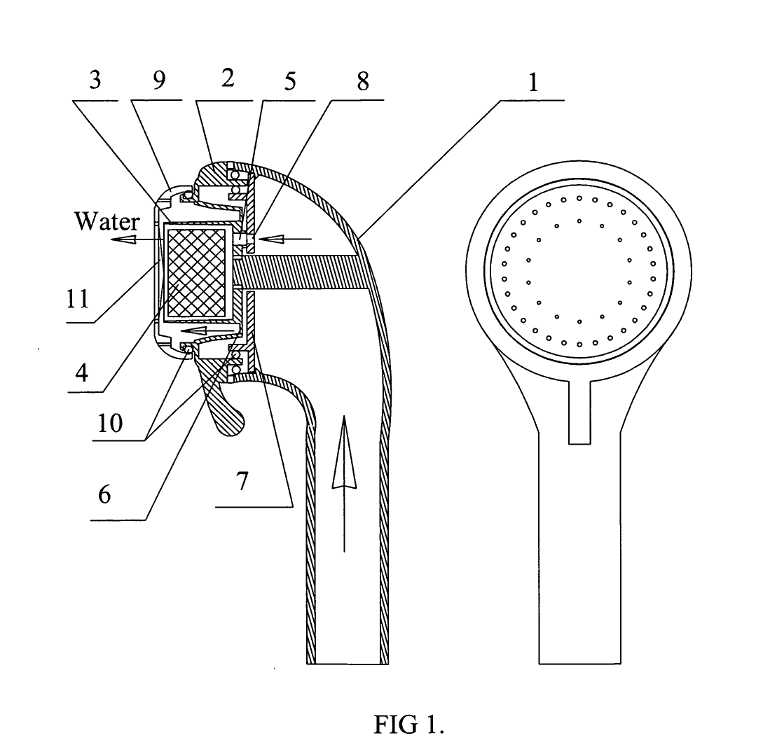

The controlled dispensing shower head as shown on FIG. 1 consist of the following parts:

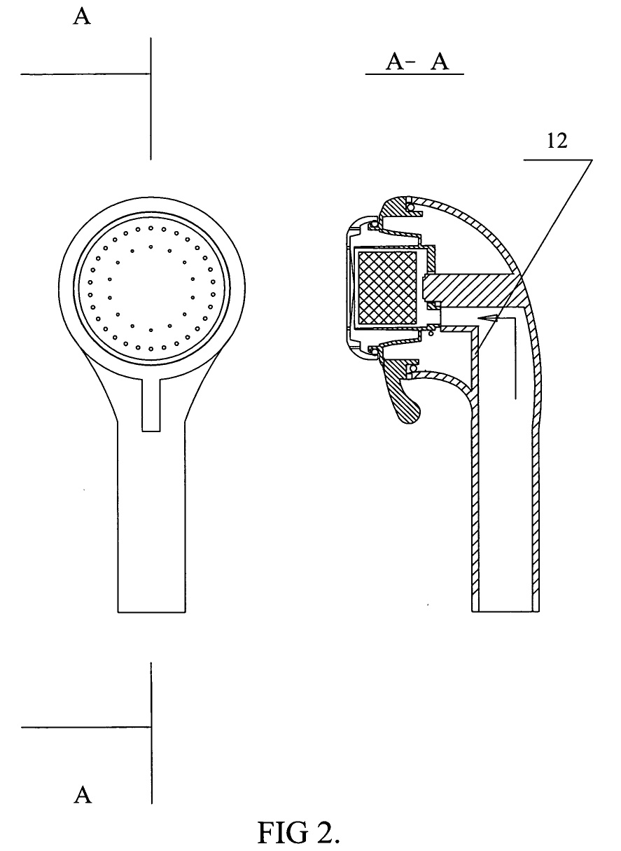

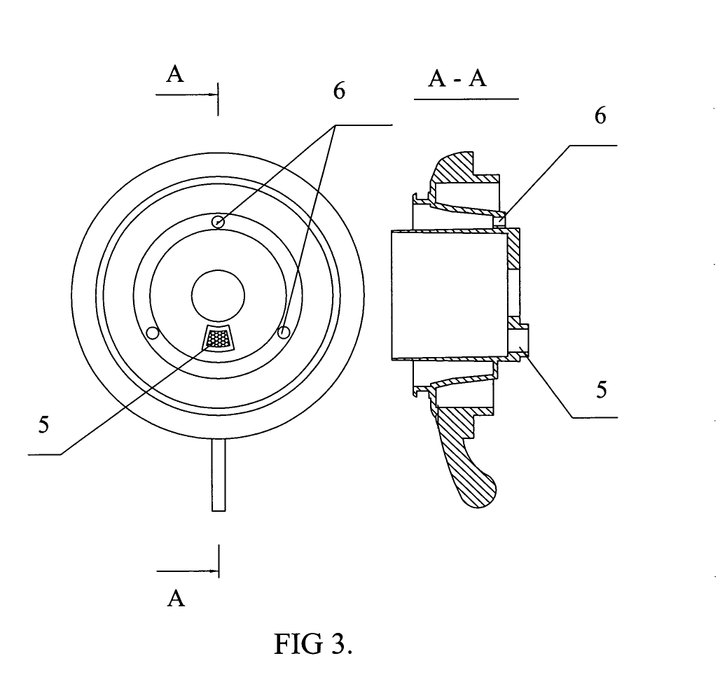

A hand-held base (handle) 1; a rotatable part 2 of nozzle of the shower, that is being able to rotate on its axis, having incorporated mixing chamber 3 which used for holding one or more water-soluble or water-dispersible solid substance 4, there is one or more holes 5 in inside part of bottom of chamber 3 where water passes through the mixing chamber 3, side holes 6 where water passes by outside of mixing chamber 3. Fixed dividing element 7 has one or more holes 8 where water passes, removable face plate 9, several seal gaskets or O-rings 10 and one or more spacers 11 for spacing the soluble solids from the face plate in order to inhibit the soluble solid from clogging the face plate. FIG. 2 shows the schematic view of the cross-section of second embodiment of a hand-held controlled dispensing shower head according to the present invention—instead of the fixed dividing element it uses ledges 12 made on the base of the handle. More detailed picture of the rotatable part of nozzle 2 with mixing chamber 3 shown on FIG. 3.

The controlled dispensing hand-held show works the following way: Water comes into the controlled dispensing hand-held show through the base of the handle 1. The dissolvable substance 4 is located inside the mixing chamber 3, where it may be placed while the removing the cap 9.

Incoming water is separated into two streams by the set of the holes in the bottom of the a mixing chamber 3 that is being incorporated into the nozzle,
first part of stream passes through (inside) the chamber 3 and provides dissolution;
second part of the stream is going outside of the mixing chamber 3 and is not involved in dissolution of the substances located in the mixing chamber 3.

The proportion between these two parts of the stream is the major factor that defines concentration of the dissolved substance.

If more water goes outside of the chamber 3—there will be less concentration of the dissolvable substance 4 in the output stream of the shower. If more water comes through the chamber 3—there will be higher concentration of the dissolvable substance in the output stream of the shower.

The proportion of the outside and inside streams of the chamber 3 is controlled and changed using the specifics of construction of the rotatable nozzle 2 with incorporated mixing chamber 3.

In order to see the range of control of the dissolvability of the substances used in the controlled dispensing hand-held shower it makes sense to overview two “extreme” positions. First position—when all water goes outside of the chamber 3—this corresponds to lowest concentration of the dissolve water-soluble or water dispersible substance. Second—when all water comes through the chamber 3—corresponds to the heighest possible concentration of the dissolve water-soluble or water dispersible substance.

Fist position (corresponds to lowest concentration of the dissolve water-soluble or water dispersible substance) is being achieved when the inside holes 5 of the mixing chamber are blocked by the fixed dividing element 7 and all the holes 6 on the outside part of the mixing chamber 3 are located in front of the holes of the fixed dividing element 7.

Second position (highest concentration of dissolve water-soluble or water dispersible substance) is being achieved when outside holes 6 of the mixing chamber 3 are blocked by the fixed dividing element 7 and all inside holes 5 of the mixing chamber 3 are located in front of the holes of the fixed dividing element 7. Rotation of the mixing chamber 3 between mentioned two “extreme” position covers full range of control for the controlled dispensing hand-held show.

Again—rotating mixing chamber 3 that is being incorporated into the nozzle 2, a movement of the holes 5,6 of the chamber are changing positions relating to the holes in fixed dividing element 7 and, as result, changing the sizes of the of the streams inside and outside of the mixing chamber 3. At the moment when the holes in bottom of the chamber are shifted away from the holes of the fixed plate, the path for incoming into the chamber stream is blocked and this stream is minimal.

The set of gaskets or O-rings 10 allows to the avoid leaks and provide an effortless and comfortable use of the shower.

Spacers 11 on the face plate 9 allow to avoid the clogging of the fixed dividing element by the dissolve water-soluble or water dispersible substance while the stream inside of the mixing chamber is substantial.

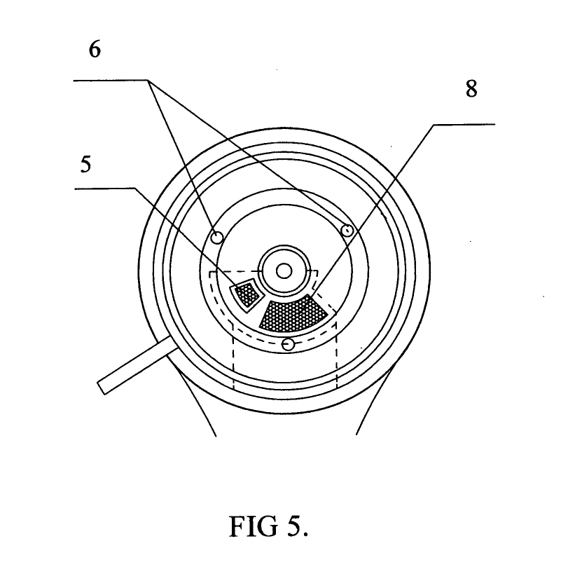

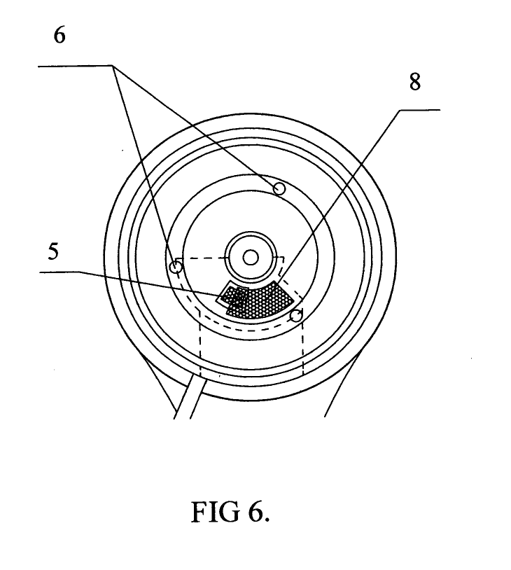

The above description outlines the role of the fixed dividing element as one of the key components in embodiment according to claim 1. Further important improvement is covered in the claim 2: According to it fixed dividing element 7 is fulfilled as a ledges on the the base 1 of the handle 1. This ledges is having hole that is being used by the for forming the internal stream of the mixing chamber 3. The passes for the external stream (outside the mixing chamber 3) is being formed based on shape of the surface of the ledges as shown on FIG. 5 and FIG. 6.

FIG. 5 illustrates that rotation of the nozzle with the mixing chamber 3 leads to the changes the sizes of the streams.

On FIG. 5 is shown position of the internal hole of the mixing chamber 5 when the inside stream of the mixing chamber 3 is blocked and all the water comes outside of the mixing chamber 3.

FIG. 6 demonstrates how the rotation of the nozzle with incorporated mixing chamber 3 leads to opening of the inside stream pass—while inside hole 5 of the mixing chamber 3 and the hole 8 on the ledge of the base 1 are overlapped. Meanwhile the outside holes 6 are going to be partially blocked.

The embodiment of the controlled dispensing hand-held shower according to the claim 2 provides a greater simplicity, it is easy in use, more safe, more effective in operation. In addition, it has a significantly low cost in manufacturing.

What we claime in our invention is:

1. A controlled dispensing hand-held shower to dissolve water-soluble or water dispersible substance comprising: hand-held base (handle), rotatable part in the nozzle of the shower, being able to rotate on its axis, having incorporated mixing chamber for receiving one or more water-soluble or water-dispersible solid substances, having one or more holes in special shaped bottom of mixing chamber where water passes through the mixing chamber and one or more side holes where water passes by aside of mixing chamber, fixed dividing element having one or more holes where water passes, removable face plate, several seal gaskets or O-rings and one or more spacers for spacing the soluble solids from the face plate thereby to inhibit the soluble solid from clogging the face plate.

2. A controlled dispensing shower, as in claim 1, wherein a dividing portion is fulfilled as a ledges of special shape inside of shower handle.
